(19) United States
(12) Patent Application Publication
(10) Pub. No.: US 2011/0166922 A1
(43) Pub. Date: Jul. 7, 2011

(54) PORTAL INCLUDING MERCHANT FUNDED AFFILIATE CASH BACK SERVICE

(76) Inventor: Zack Fuerstenberg, Toronto (CA)

(21) Appl. No.: 12/848,473

(22) Filed: Aug. 2, 2010

Related U.S. Application Data
(60) Provisional application No. 61/292,775, filed on Jan. 6, 2010.

(51) Int. Cl. G06Q 30/00

(52) U.S. Cl. 705/14.39; 705/14.1

(57) ABSTRACT

A system and method for managing a rewards program are provided. The method includes receiving information about a consumer, registering the consumer information and creating unique tracking information associated with the consumer. The method further includes receiving a listing of one or more merchants offering an incentive to the consumer, providing the listing to the consumer, receiving input indicative of selection of a merchant, and directing the consumer to a merchant website associated with the selected merchant. Thereafter, the method includes receiving details about an item purchased by the consumer, receiving a total value of an reward for the item purchased by the consumer, calculating a first share of the incentive to be offered to the consumer, and communicating the first share to an issuer of the payment device used by the consumer to be included in a statement provided to the consumer.

### CROSS-REFERENCES TO RELATED APPLICATIONS

The present application claims benefit under 35 U.S.C. §119(e) of U.S. Provisional Patent Application No. 61/292,775, entitled “Portal Including Merchant Funded Cash Back Service”, filed Jan. 6, 2010, the content of which is hereby incorporated by reference in its entirety for all purposes.

### BACKGROUND

Online shopping has been increasing exponentially over the past decade. Online shopping revenue now accounts for over 25% of the overall shopping revenue generated by merchants. As online shopping continues to increase, merchants are looking into new ways to attract consumers to shop online. One of the ways for merchants to attract consumers to shop with them is to offer incentives to the consumers. Some of the most common incentives offered by merchants include cash back, discounts on items, reward points, or loyalty rewards.

However, since there are numerous shopping avenues on the Internet, it becomes difficult for a consumer to keep track of the merchants that offer incentives for shopping at their websites. In order to entice a consumer to increase his online shopping, merchants, credit card issuers, and payment processors are increasingly finding innovative ways to inform and attract consumers.

In spite of the increased efforts by merchants to attract consumers to their website, many merchants are still unable to attract consumers to their website. A new type of marketing technique called Affiliate Marketing is being increasingly used by merchants to attract consumers. Affiliate Marketing is an Internet-based marketing practice in which a business (merchant) rewards one or more affiliates for each visitor or consumer brought about by the affiliate's marketing efforts. An affiliate usually operates a website that may list several merchants and the incentives offered by the merchants. The promotion of the affiliate website is handled by the affiliate. Examples of affiliates include double click, value click, etc. When a consumer visits the affiliate website and “clicks” on one of the merchant offers to visit the merchant website and completes a transaction, the merchant provides some reward to the affiliate, e.g., a percentage of the sale amount for that transaction or a fixed amount for every consumer that arrives at the merchant website via the affiliate website. This can be referred to as the ‘affiliate bounty’. This collaboration with an affiliate network helps the merchant attract more consumers to its site and helps the affiliate network generate revenue for itself.

One of the other benefits for the merchant in an affiliate marketing scheme is that the merchant does not have to spend resources in attracting consumers. The merchant can focus on his core competencies like providing quality goods for a reasonable price. The savings realized by the merchant on the marketing and advertisement costs can translate into lower prices for the consumers.

However, in this type of arrangement, the only incentive that can be offered to the consumer is usually limited to lower prices. Most of the online shopping is facilitated by use of payment device like credit and debit cards. The issuers of these cards may have their own incentives that they offer their members for shopping using their payment card. However, any such incentive is independent of the affiliate marketing process since these two programs cannot be currently linked together in a meaningful manner. It would be advantageous for the consumer if he can share from some of the affiliate bounty without having to take additional efforts in order to share the affiliate bounty.

What is needed is a system for seamlessly merging the affiliate marketing concepts with the existing payment processing mechanism to provide consumers with a hassle free way of sharing in the affiliate bounty in a seamless manner.

### SUMMARY

Embodiments of the invention generally relate to the field of online shopping and more specifically to methods and systems for managing rewards programs for consumers.

Embodiments of the present invention provide a method for managing a reward program. The method comprises providing a listing including one or more merchants to a consumer, receiving authentication information, from a client computer operated by the consumer, and generating unique tracking information associated with the consumer. The method further comprises receiving information about selection of a merchant of the one or more merchants, directing the client computer to a website of the selected merchant, receiving purchase details about an item purchased by the consumer from the selected merchant where the purchase details include the unique tracking information, and determining a first share from a total reward to be offered to the consumer based at least in part on the purchase details and the total reward.

In some embodiments, providing a listing including one or more merchants includes: receiving the listing from an affiliate aggregator; and providing the listing to the consumer. The method further comprises receiving the total reward offered by the merchant for the item purchased by the consumer and communicating information about the first share to an issuer of the payment device, wherein the first share is included in an account statement provided to the consumer. In some embodiments, providing the listing to a consumer includes displaying the listing of the one or more merchants including incentives offered by the one or more merchants at a dedicated a website or sending an email to the consumer including the listing of the one or more merchants.

In some embodiments, receiving purchase details about the item purchased by the consumer includes receiving the purchase details from an affiliate aggregator. In some embodiments, determining the first share includes analyzing the purchase details; matching the unique tracking information with the payment device; and determining, based on one more criteria, the amount of reward to be offered to the consumer. In some embodiments, the method further comprises determining a second share from the total reward to be communicated to the affiliate aggregator, determining a third share from the total reward to be communicated to the issuer, and determining a fourth second share from the total reward to be retained, wherein the second share, the third share, and the fourth share is determined based on predetermined criteria. In some embodiments, the unique tracking information comprises one of a random number assigned to the consumer, an alias associated with the consumer, a cookie resident on the client computer, or a hash of a consumer account number.

Some embodiments of the present invention provide a computer readable storage medium including instructions which when executed by a processor embedded in a computer system cause the processor to perform a method for managing rewards. The method includes receiving authentication information of a consumer from a client computer operated by the consumer and generating unique tracking information associated with the consumer, receiving information, from the client computer, about selection of a merchant of the one or more merchants, directing the consumer to a website of the selected merchant, receiving purchase details about an item purchased by the consumer from the selected merchant, the purchase details including the unique tracking information; and determining a first share from a total reward to be offered to the consumer, based at least in part on the purchase details and the total reward. In some embodiments, the method further includes calculating a second share, from the total reward, of the affiliate network, calculating a third share, from the total reward, of the issuer of the payment device; and retaining a fourth share from the total value of the incentive.

In some embodiments, the total reward is in form of cash back, rewards points, or loyalty program points, and the method further comprises receiving the total reward offered by the merchant for the item purchased by the consumer, and communicating information about the first share to an issuer of the payment device, wherein the first share is included in an account statement provided to the consumer. In some embodiments, communicating information about the first share first share to an issuer further includes providing the unique customer tracking information to the issuer. In some embodiments, calculating the first share of the consumer is performed based on one or more predetermined criteria.

Some embodiments of the present invention provide a method performed by a server computer. The method comprises receiving information about a consumer and information about a payment device associated with the consumer, registering, by the server computer, the consumer as an authorized consumer, providing a listing of one or merchants to a client computer, receiving input from the client computer indicating selection of a merchant from the one or merchants, directing the client computer to a website of the selected merchant, receiving details of transaction performed by the consumer with the selected merchant using the payment device, receiving a total reward awarded by the merchant for the transaction performed by the consumer, determining a first share of the consumer, a second share of an issuer of the payment device, and a third share to be retained by an entity managing the server computer, and communicating the first share to the issuer for inclusion in a statement provided to the consumer.

In some embodiments, the listing of one or more merchants includes receiving the listing from an affiliate aggregator, and providing the listing to the consumer via a website. In some embodiments the method further includes determining a fourth share, from the total reward, to be allocated to the affiliate aggregator. In some embodiments, receiving details of the transaction performed by the consumer includes receiving the details from an affiliate aggregator, wherein the details of the transaction include payment information and unique tracking information associated with the consumer. In some embodiments, determining a first share of the consumer comprises matching the unique tracking information associated with the consumer to the payment device used by the consumer to perform the transaction, and determining the first share based on the details of the transaction and a criteria established by the issuer of the payment device. In some embodiments, providing a listing of one or merchants comprises providing the listing of the one or merchants on a web portal operated by a payment processing network, or providing the listing of the one or merchants on an issuer-branded web portal.

Certain embodiments of the present invention provide a system for managing a reward program. The system comprises a server computer configured to host a merchant portal displaying a listing of one or more merchants offering an incentive to consumers, an affiliate aggregator communicably coupled to the server computer and configured to provide information about the one more merchants to the server computer, and an issuer computer communicably coupled to the server computer and configured to receive information about a reward share for a consumer and include the reward share on a statement provided to the consumer, the issuer being associated with a payment device used by the consumer. The server computer is further configured to receive information, from the affiliate aggregator, about a transaction performed by the consumer, using the payment device, at a merchant location and a total reward offered by the merchant for the transaction, calculate a first share of the consumer, a second share for the affiliate aggregator, a third share for the issuer, and a fourth share to be retained by a payment processing network managing the server computer. In some embodiments, the server computer is further configured to include the first share of the consumer directly on the statement provided to the consumer. In some embodiments, the server computer is further configured to receive, from the affiliate aggregator, information about unique tracking information associated with the consumer.

The following detailed description, together with the accompanying drawings will provide a better understanding of the nature and advantages of the present invention.

### BRIEF DESCRIPTION OF THE DRAWINGS

FIG. 1 is a block diagram illustrating a conventional payment card transaction process.

FIG. 2 is a block diagram of a system for managing a rewards program according to an embodiment of the present invention.

FIG. 3 is a block diagram of a server computer that may be used to manage a rewards program according to an embodiment of the present invention.

FIG. 4 illustrates a table that may be stored in the consumer database according to an embodiment of the present invention.

FIG. 5 is a flow diagram of a method for implementing a rewards program according to an embodiment of the present invention.

FIG. 6 illustrates a representative user interface screen of a merchant portal according to an embodiment of the present invention.

FIG. 7 is a block diagram of a computer that may be used to implement various components of the system for managing the rewards program according to an embodiment of the present invention.

### DETAILED DESCRIPTION

Embodiments of the present invention provide a method and system for managing a reward program.

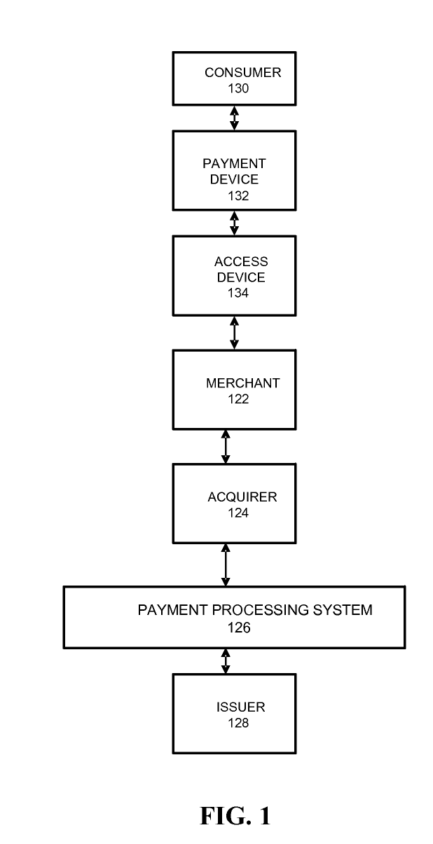

FIG. 1 shows a system 120 for performing a transaction using a payment processing network. The system 120 includes a merchant 122 and an acquirer 124 associated with the merchant 122. In a typical payment transaction, a consumer 130 may purchase goods or services at the merchant 122 using a payment device 132. The acquirer 124 can communicate with an issuer 128 via a payment processing network 126. The consumer 130 may be an individual, or an organization such as a business that is capable of purchasing goods or services. The issuer 130 may operate a server computer configured to receive a payment authorization request message from the payment processing network 126 and provide an appropriate reply in the response to the payment authorization request.

The payment device 132 may be in any suitable form. For example, suitable payment devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, and the like. The payment devices can also be debit devices (e.g., a debit card), credit devices (e.g., a credit card), or stored value devices (e.g., a stored value card).

The payment processing network 126 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 126 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 126 may use any suitable wired or wireless network, including the Internet.

The merchant 122 may also have, or may receive communications from, an access device 134 that can interact with the payment device 132. The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 134 is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with the payment devices 132.

In a typical purchase transaction, the consumer 130 purchases a good or service at the merchant 122 using a payment device 132 such as a credit card. The consumer's payment device 132 can interact with an access device 134 such as a POS (point of sale) terminal at the merchant 122. For example, the consumer 130 may take a credit card and may swipe it through an appropriate slot in the POS terminal. Alternatively, the POS terminal may be a contactless reader, and the payment device 132 may be a contactless device such as a contactless card.

An authorization request message is then forwarded to the acquirer 124. After receiving the authorization request message, the authorization request message is then sent to the payment processing network 126. The payment processing network 126 then forwards the authorization request message to the issuer 128 of the payment device 132.

After the issuer 128 receives the authorization request message, the issuer 128 sends an authorization response message back to the payment processing network 126 to indicate whether or not the current transaction is authorized (or not authorized). The transaction processing system 126 then forwards the authorization response message back to the acquirer 124. The acquirer 124 then sends the response message back to the merchant 122.

After the merchant 122 receives the authorization response message, the access device 134 at the merchant 122 may then provide the authorization response message for the consumer 130. The response message may be displayed by the POS terminal, or may be printed out on a receipt.

At the end of the day, a normal clearing and settlement process can be conducted by the transaction processing system 126. A clearing process is a process of exchanging financial details between and acquirer and an issuer to facilitate posting to a consumer's account and reconciliation of the consumer's settlement position. Clearing and settlement can occur simultaneously.

Traditionally merchants have offered various incentives to card holders to shop at their sites. Merchants have to expend substantial money in order to promote their business and attract consumers. In recent years, merchants have collaborated with affiliate networks in order to increase their presence on the on-line world and increase their exposure to potential new customers. An affiliate network may list one or more merchant offers on a website referred to an ‘affiliate website’. The merchant and the affiliate network may have an agreement that if a consumer visits the merchant website through the affiliate website and completes a purchase, the merchant will provide a certain percentage (bounty) of sales amount to the affiliate network. A consumer may then visit a merchant through the affiliate website and complete a purchase. The affiliate network tracks the consumer's movement and at a later time invoices the merchant to collect the appropriate bounty from the merchant. Typically, an affiliate network may list multiple merchant offers. The affiliate network takes care of marketing and the merchant does not have to invest in marketing efforts.

In this arrangement, the consumer and the issuer of the payment device used by the consumer to complete the purchase typically do not receive any share of the bounty collected by the affiliate network. Lately, some merchants have begun offering some sort of incentive to the consumers, but there is no systematic way of tracking purchases by the consumers or ensuring that the consumers receive the incentives offered by various merchants.

Embodiments of the present invention provide a system for managing a rewards program by providing an integrated solution wherein all aspects of a rewards program are managed by a single entity. The system provides a merchant portal for use by the consumers, provides unique tracking information to track a particular consumer as he navigates through the purchase process, determines the share of the bounty each of the entities involved in the transaction process (affiliate network, consumer, issuer, etc), and posts information about the consumer's share directly onto a statement provided to the consumer. Such a system can be provided, e.g., by a payment processing network described above.

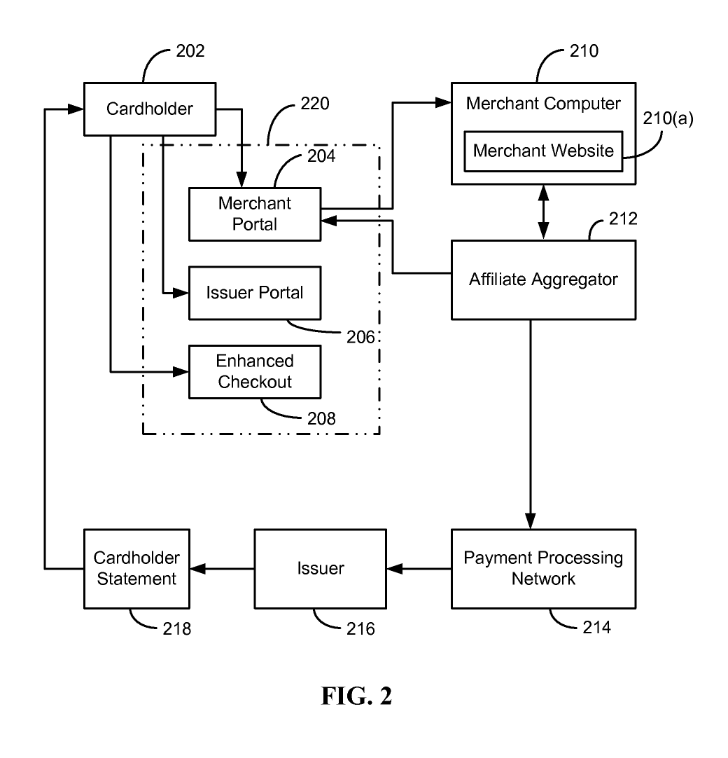

FIG. 2 is a block diagram for a system 200 for managing a reward program by providing statement credits to consumers according to an embodiment of the present invention. System 200 includes a client computer 202 that a consumer can use to conduct online transactions, e.g., purchasing a product. A consumer can use the client computer 202, e.g., a phone, a personal computer, etc.) to access a merchant portal 204 provided by e.g., a payment processing network. Client computer 202 can be implemented using any general purpose computer with the requisite ability to access the Internet.

The system 200 may also include a merchant portal 200. The merchant portal 204 can list one or more merchants. Each of the merchants listed on merchant portal 204 may offer some type of incentive for the consumer. In some embodiments, the listing of merchants can be presented in such a manner that the consumer can ‘click’ on an icon or a link representing the merchant. Upon clicking the icon (or a link), the consumer's computer 202 may be directed to a website 210(a) associated with the merchant where the consumer can avail himself of the incentive offered by that merchant. It is to be noted that merchant portal 204 is not the only means of communicating/presenting merchant offers to consumers. In some embodiments, the offers may be presented to the consumer via a mobile communication device, e.g., a mobile phone, PDA, etc. In other embodiments, the merchant offers may be presented to the consumer via targeted medium such as a kiosk, an ATM machine, television, email, SMS, etc. The consumer may act upon an offer presented to him via any of the presentation methods discussed above. In the instance that merchant offers are presented on the consumer's mobile device, a payment application resident of the consumer's mobile device may be used to present the offers and track the consumer's actions for those offers. The mobile payment application can be configured to enable the consumer to redeem the offers and send transaction details to the payment processing network in order to calculate the consumer's share of the affiliate bounty.

In some embodiments, in order to be listed on merchant portal 204, the merchants may provide certain percentage of revenue generated through merchant portal 204 to the entity operating the portal. Any suitable percentage (e.g., less than 10%) may apply. Further, the merchant portal 204 may be hosted by an independent entity, e.g., a payment processing network. The payment processing network may operate a payment processing network server computer 220 that can host the merchant portal 204 and/or an issuer branded portal 206. As described above, an issuer is an entity that issues a payment device, e.g., a credit card. The issuer may operate a server computer. In some embodiments, an issuer may want to provide some incentives to its customers to encourage the customers to shop using the payment device issued by the issuer. This increases the issuer's revenue stream in the form of increased transaction fees and potentially interest on unpaid debt of its customers.

An embodiment of the present invention provides the issuer with a customized portal for its consumers. By way of the issuer portal 206, the issuer 216 is able to control the offer process by specifying which merchants are to be listed on the issuer portal and what type of offers it wants to provide to the consumers. While many big issuers, e.g., Bank of America, may be able to manage and run a merchant portal on their own, there are several small issuers that lack the resources to create and manage such a merchant portal. In some embodiments, several issuers can collaborate with the payment processing entity operating the payment processing entity server computer 220 to strike favorable agreements with merchants and thereby offer meaningful incentives to their customers. The payment processing network may operate the portal on behalf of the issuers. In some embodiments, each issuer may have a separate issuer portal 206 customized for their customers.

In some embodiments, the payment processing network may also provide an enhanced checkout platform 208 for the consumers. The enhanced checkout service 208 works in a similar manner as the merchant portal 204. For ease of explanation, the rewards management system will be described henceforth with reference to merchant portal 204, but it is to be understood that the system and methods described below apply equally to the issuer portal 206 and the enhanced checkout service 208.

In some embodiments, a consumer wishing to avail himself of the offers provided by the merchants may register with the payment processing network that operates the merchant portal 204. In some embodiments, as part of the registration process, the consumer may also register one or more payment devices that he intends to use for conducting online transactions. In some embodiments, the payment processing entity server computer 220 saves consumer information in a database and generates unique tracking information for the consumer. Whenever the consumer logs in to the merchant portal 204 and navigates to a merchant site 210(a), the unique tracking information accompanies the consumer all the way through the purchase process. In some embodiments, the unique tracking information may be a random number assigned to the consumer, an alias associated with the consumer, a cookie resident on the client computer 202, a hash of the consumer account number, or an alphanumeric code.

In some embodiments, payment processing entity operating the payment processing entity computer server 220 may collaborate with an affiliate network operating an affiliate aggregator 212 in order to obtain a listing of merchants to be displayed on the merchant portal 204. The affiliate aggregator may be embodied by a server computer. In other embodiments, the payment processing network may directly negotiate with the merchants to secure incentives from them. As described above, the affiliate aggregator 212 may provide a listing of merchants to the payment processing network server 220 so that those merchants are now visible to any consumer visiting the merchant portal 204.

System 200 also includes a merchant computer 210 (e.g., a merchant server computer server) operating a merchant website 210(a). In some embodiments, when a consumer, using the client computer 202, clicks on a coded link for a merchant on the merchant portal 204, the client computer 202 is directed to the merchant website 210 (a). Once there, the consumer can use conventional means for buying an item at the merchant. While the consumer is purchasing the item from the merchant website 210(a), his on-line movements are tracked by the affiliate aggregator 212. Once the consumer completes the purchase, the details of the purchase are recorded by the affiliate aggregator 212.

In some embodiments, the payment card details of the payment device used by the consumer are not exposed to the affiliate aggregator 212. The affiliate aggregator 212 tracks the consumer using the unique tracking information associated with the consumer. Periodically, the affiliate aggregator 212 provides an accounting to the merchant about the number of consumers who visited the merchant operating the merchant computer 210 via the merchant portal 204. The affiliate aggregator 212 may also provide information about purchased items at the merchant. The merchant can then provide the affiliate bounty associated with those purchases to the affiliate aggregator 212. In some embodiments, the affiliate aggregator 212 then forwards the affiliate bounty to the payment processing entity server computer 220 for further distribution.

The system 200 also includes a payment processing network 214, which is similar to the payment processing network 126 described in relation to FIG. 1. As described above, an issuer 216 is an entity that issues a payment device such as a credit card. In some embodiments, issuer 216 is a financial institution, e.g., Chase Manhattan Bank. The issuer 216 provides an account statement 218 to the cardholder on a periodic basis, e.g., monthly. The account statement 218 includes details about all the purchases and credits made on the payment card during a specified period. In some embodiments, the payment processing entity server computer 220 may be part of the payment processing network 214 and may be managed by the same payment processing network.

In some embodiments, a consumer may logon to the merchant portal 204 using unique credentials, e.g., login ID and password, provided to him by the payment processing network server 220 at the time of registration. In some embodiments, the payment processing network server 220 may also generate unique tracking information and associate that with the consumer at the same time. Once signed in, the consumer may visit the merchant website 210(a) on the merchant server 210 by clicking on a coded link provided on the merchant portal 204. After the consumer completes a purchase at the merchant website 210(a), the affiliate aggregator 212 captures the details of the purchase, provides an accounting to the merchant, and collects the affiliate bounty associated with that transaction from the merchant. Thereafter, the affiliate aggregator 212 provides the affiliate bounty and the details of the purchase along with the unique tracking information of the consumer to the payment processing network 214. The payment processing network 214 (or server computer therein) calculates the consumer's share of the affiliate bounty based on predetermined criteria and provides that information to the issuer 216. The information about the consumer's share is included in the account statement 218 provided to the consumer.

In some embodiments, the payment processing network 214 can aggregate all of the cash back due to consumers at the participating issuer 216 and send a statement credit file to the issuer 216 with payment instructions for posting the cash back to registered consumers' account statements using the statement crediting capabilities of the payment processing network 214 to clear and settle the cash back rebates. In some embodiments, system 200 can also enable reversals, password resets, and other customer service transactions for the participating issuer to undertake in support of their consumers.

It is to be understood that the system 200 may include additional components in addition to or in lieu of the components illustrated in FIG. 2. Further, while the system 200 is described herein with reference to particular blocks, it is to be understood that these blocks are defined for convenience of description and are not intended to imply a particular physical arrangement of component parts. Further, the blocks need not correspond to physically distinct components.

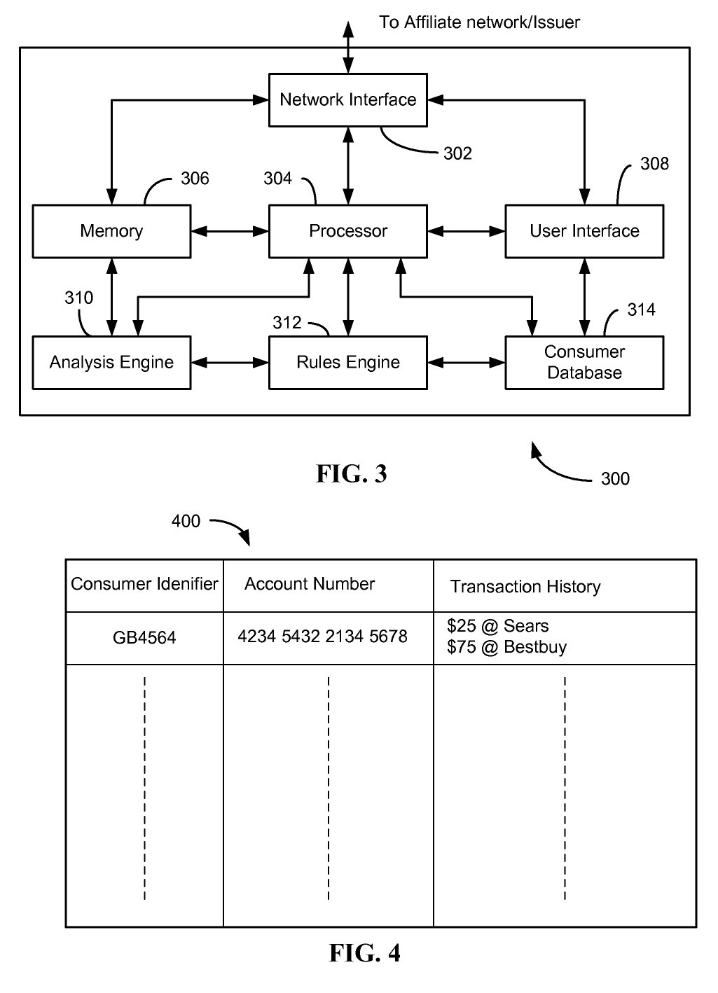

As described above, the payment processing network 214 receives information about the transactions and the affiliate bounty from the affiliate aggregator 212 and calculates shares of the various entities. In some embodiments, the payment processing network 214 can include a computer system that is configured to perform this task. FIG. 3 illustrates a block diagram of a computer system 300 that is configured to manage the distribution of the affiliate bounty according to an embodiment of the present invention. The computer system 300 comprises a network interface 302, a processor 304, a memory 306, a user interface 308, an analysis engine 310, a rules engine 312, and a consumer database 314.

Network interface 302 can allow the payment processing network server 300 to communicate with other devices on a network and exchange information with the other devices, e.g., the issuer and the affiliate aggregator. In some embodiments, the network interface 302 can include radio frequency (RF) transceiver components for accessing wireless voice and/or data networks (e.g., using cellular telephone technology, advanced data network technology such as 3G or EDGE, WiFi (IEEE 802.11 family standards), or other mobile communication technologies, or any combination thereof), GPS receiver components, and/or other components. In some embodiments, network interface 302 can provide wired network connectivity (e.g., Ethernet) in addition to or instead of a wireless interface. The network interface 302 can be implemented using a combination of hardware (e.g., antennas, modulators/demodulators, encoders/decoders, and other analog and/or digital signal processing circuits) and software components.

Processor 304, which can be implemented as one or more integrated circuits (e.g., a conventional microprocessor or microcontroller), can control the operation of the payment processing network server 300. For example, the processor 302 can instruct the analysis engine 310 to perform calculations to determine the consumer's share from the affiliate bounty.

Memory 306 can be implemented, e.g., using disk, flash memory, or any other nonvolatile storage medium. In some embodiments, the memory 306 can store program instructions that are executable to calculate the consumer's share of the affiliate bounty, perform complex charge-back calculations, etc. In some embodiments, the memory 306 can include the consumer database 314. In some embodiments, the memory 306 can store the information received from an affiliate network that includes the transaction details and affiliate bounty information for one or more consumers registered with the payment processing network.

In some embodiments, the computer readable storage medium includes instructions which when executed by a processor embedded in a computer system cause the processor to perform a method for managing rewards, the method comprising: receiving, from a client computer, information about a consumer; registering the consumer information and creating unique tracking information associated with the consumer; receiving a listing of one or more merchants from an affiliate aggregator, each of the merchants offering an incentive to the consumer; providing the listing to the consumer via a client computer; receiving input from the client computer, the input indicative of selection, by the consumer, of a merchant from the listing of the one or more merchants; directing the client computer to a merchant website associated with the selected merchant; receiving, from the affiliate aggregator, details about an item purchased by the consumer at the selected merchant, the details including information about a payment device used by the consumer to purchase the item; receiving, from the affiliate aggregator, a total value of an incentive for the item purchased by the consumer; calculating a first share, from the total value of the incentive, to be offered to the consumer; and communicating the first share to an issuer of the payment device used by the consumer, wherein information about the first share is included in a statement provided to the consumer.

User interface 308 can be used to accept inputs from a consumer. In some embodiments, the user interface 308 can be used to perform management functions for the computer system 300. The user interface 308 can include input controls such as a touch screen, touch pad, scroll wheel, click wheel, dial, button, keypad, microphone, or the like. The user interface 308 can also include one or more consumer output devices, such as indicator lights, speakers, headphone jacks or the like, together with supporting electronics (e.g., digital-to-analog or analog-to-digital converters, signal processors or the like). A consumer can operate the various input controls of the user input interface 308 to invoke the functionality of the computer system 300 and can view and/or hear output from the computer system 300.

Analysis engine 310 can be implemented as one or more integrated circuits, e.g., a microcontroller. The analysis engine 310 can receive input from the business rule engine 312 and the affiliate bounty information from the affiliate aggregator to determine a first share of the consumer, a second share of the affiliate network, a third share of the issuer, and a fourth share to be retained by the payment processing network. In some embodiments, the analysis engine 310 includes programming and logic to receive inputs from the business rule engine 312 about the criteria for calculating the various shares from the affiliate bounty and receive the information about the purchase details from an affiliate network. Based on the received information the analysis engine 310 can calculate the individual shares of the various entities. The various “shares” may be in any suitable percentages of the total reward (affiliate bounty) offered by the merchant. For example, if the total reward is equal to 10% of the purchase price by the consumer, the first, the second, the third, and the fourth share may each be in the range of 0% to 50% of the total reward amount.

One of the advantages of performing the calculations by the payment processing network is that the payment processing network interfaces with the merchant, the issuer, the consumer and the affiliate aggregator. For example, the payment processing network can interface with the consumer via the merchant portal and create unique transaction information for the consumer. The payment processing network can also interface with the merchant to include the merchant offers on the merchant portal and with the affiliate network to receive purchase information. The payment processing network can also interface with the issuer for communicating authorization and authentication messages for the user payment device and for communicating the amount to be included in the user account statements. Thus, the payment processing network acts as a neutral party who facilitates the reward process for the merchant, affiliate aggregator, consumer and the issuer. No other party involved in the process has this unique ability as does the payment processing network.

In some embodiments, the information received from the affiliate aggregator includes transaction details associated with one or more consumers along with the unique tracking information for each of the one more consumers. The analysis engine 310 can then match details of each transaction with the appropriate consumer using the unique consumer tracking information, calculate the consumer's share of the affiliate bounty, and create a settlement credit file to be sent to the issuer. The issuer may then post the credit to the appropriate consumer's account statement. In some embodiments, the computer system 300 can post the credit directly on the consumer's statement.

Business rules engine 312 can include the criteria to be used for calculating the various shares for the consumer, the affiliate network, the issuer, and the payment processing network. In some embodiments, the business rules engine 312 can include issuer-based parameters for calculating the various shares from the affiliate bounty that would be made available to the consumer and the issuer. In some embodiments, the payment processing network managing the payment processing network server 220 can enter into agreements with issuers, and/or affiliate networks to establish rules for revenue sharing from the affiliate bounty provided by the merchants. For example, the agreement may include specific rules on how to allocate the affiliate bounty received from the merchant between the consumer, issuer, affiliate network and the payment processing network. In some embodiments, the rules can be established on an issuer-by-issuer basis. In other embodiments, the rules can be consumer-centric, e.g., cash back can be increased based on the number or amount of purchases made by the consumer using the merchant portal. In some embodiments, the payment processing network can enter into agreements with the merchants directly bypassing the affiliate networks. In such an instance, the payment processing network managing the computer system 300 may be able to offer even a bigger share of the merchant supplied bounty to the consumer and issuer. In some embodiments, the business rules engine 312 can also include rules for reversing a reward previously posted if the associated transaction for which the reward was initially posted is reversed, e.g., the consumer returns an item for which a cash back reward was earned. One skilled in the art will realize that business rules engine may also include various other rules and criteria not specifically mentioned above.

Consumer database 314 can be implemented, e.g., using disk, flash memory, or any other nonvolatile storage medium. As described above, in some embodiments, consumer database 314 can be resident in the memory 306. Consumer database can include information linking the unique consumer tracking information with the consumer's real account information, e.g., a credit card number. FIG. 4 shows a sample table 400 with information that may be included in consumer database 314. In some embodiments, consumer database can include a history of transactions conducted by each consumer using their payment devices, e.g., credit cards, debit cards, etc. The transaction history may be used to provide target advertisements/offers for the consumer thus increasing the likelihood of the consumer actually redeeming the offers presented to him. It is to be noted that the consumer database 314 may include additional information not specifically mentioned herein or illustrated in table 400.

In some embodiments, the computer system 300 may also provide other functionality such as, account management functions for the consumers, other customer service transactions for the participating issuers for support of their consumers, etc.

Further, while the computer system 300 is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of devices including electronic devices implemented using any combination of circuitry and software.

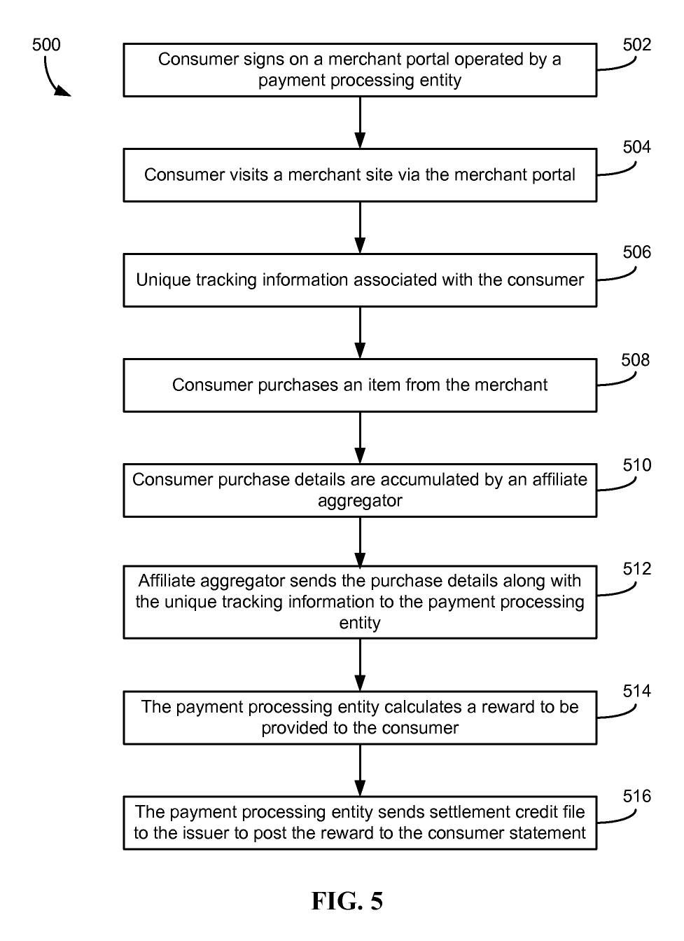

As described above, system 200 can be used to manage a rewards program where the consumer's share of the reward can be directly posted to an account statement associated with a payment device of the consumer. FIG. 5 is a flow diagram of a process 500 for managing a rewards program according to an embodiment of the present invention.

In some embodiments, prior to start of process 500, a consumer may register with the payment processing network managing the rewards program. As part of the registration, the consumer may also register one or more payment devices with the payment processing network. It is to be understood that consumer pre-registration is not necessary for process 500. A consumer can sign on to a dedicated service, e.g., the merchant portal 204 of FIG. 2, using a logon ID and password (502). In some embodiments, the consumer credentials, e.g., logon ID and password, are mapped to one or more payment devices of the consumer.

In some embodiments, once the consumer signs-on to the dedicated service and is in communication with the payment processing entity server computer 220, unique tracking information may be generated and associated with the consumer. The unique tracking information can be static or dynamic. Static tracking information is created only once and remains associated with a consumer for all transactions. Dynamic tracking information is the information that is generated every time a consumer signs-on to the dedicated service. In this embodiment, the unique tracking information may change each time the merchant portal 204 is accessed by the consumer.

Once the consumer signs on to the service, the payment processing entity operating the payment processing entity server computer 220 can determine the identity of the consumer based on the logon credentials supplied by the consumer using the client computer 202. Once signed in, the consumer's client computer 202 is presented with a list of merchants who are offering certain incentives for shopping with them. In some embodiments, the list of merchants and the associated incentives offered by each merchant are provided to the consumer. In some embodiments, the listing of merchants is presented as a link to a merchant website. Other suitable methods of presentation may be used depending on the application.

As described above, the list of merchants may be provided by an affiliate network. To avail himself of an incentive, the consumer, using the client computer 202, can ‘click’ on any of the links listed on the merchant portal 204 and visit the merchant's website (504). Upon accessing a link, the merchant portal 204 directs the consumer to the selected website (e.g., the merchant website 210(a)) and during the process associates the unique tracking information, e.g., a random code, with the consumer (506). This tracking information follows the consumer throughout the purchase process and is used to track and attribute the purchase to the consumer. In some embodiments, the tracking information may include a coded link that identifies the origin of the transaction for the merchant. By analyzing the code included in the link, the merchant computer 210 can determine that the transaction originated from, e.g., merchant portal 104. This information is helpful later in determining the various shares from the merchant/affiliate bounty. In some embodiments, the tracking information can be a cryptographic hash of the consumer logon ID or an encrypted form of other consumer information such as, the account number. In other embodiments, the tracking information can include a discrete, automated, randomized code.

After the consumer is directed to the merchant website 210(a), the consumer can purchase an item from the selected merchant based on the offer (508) according to conventional on-line purchase process. In some embodiments, the consumer need not provide his credit card number to the merchant. Instead, the consumer provides an alias (e.g., a phone number, a nickname, etc.) associated with the credit card number. Using a server and a database coupled to the server computer, the payment processing network 214 can map the alias to the actual account number as part of the payment authorization process.

After the consumer completes a transaction at the selected merchant, the affiliate aggregator 212 gathers the purchase related data (510) from the merchant computer 210. The purchase related data gathered by the affiliate network includes purchase details such as, item description and amount paid. In addition, the gathered data may also include the tracking information associated with the consumer. In some embodiments, purchase data related to multiple purchases by the consumer is aggregated by the affiliate aggregator 212. The affiliate aggregator 212 presents this information to the merchant computer 210, e.g., by providing a monthly accounting for relevant purchases, and collects the affiliate bounty offered by the merchant for those transactions. The affiliate aggregator 212 then provides the gathered data to the payment processing entity server computer 220 along with the affiliate bounty (512). As describe above, the information provided to the payment processing entity server computer 220 also includes the unique tracking information for each consumer. For example, if the merchant offer is 10% cash back on all purchases, the affiliate network collects an amount equal to 10% of the purchase value from the merchant and sends that to the payment processing network. At no point are the consumer's account details exposed to the affiliate network. The affiliate network merely sees the tracking information associated with each consumer.

Once the payment processing entity server computer 220 receives the purchase related data from the affiliate aggregator 212, the payment processing entity server computer 220 can then calculate the shares for the consumer, the issuer 216, the affiliate aggregator 212, and the payment processing entity operating the payment processing entity server computer 220 (514) from the total reward/affiliate bounty.

Any suitable shares may be provided to the consumer, issuer, the affiliate network, and the payment processing entity. For example, in some embodiments, each of these entities may get less than about 10% or less than about 5% of the purchase price of the product being purchased by the consumer. The shares may also be the same or different for the various entities in embodiments of the invention.

As described above, the analysis engine 310 can perform this calculation. For instance, once the payment processing entity sever computer 220 receives the purchase related data, it can match the unique tracking information for each purchase transaction with the appropriate consumer and thus calculate how much of the affiliate bounty is to be provided to each consumer. Once the consumer share is calculated, the payment processing entity sever computer 220 creates a settlement credit file that includes the share information and other account related information for the consumer. The settlement credit file specifies the amount of reward to be provided to each consumer. The settlement credit file is sent to the appropriate issuer for posting to the account statement of each consumer (516). In some embodiments, the payment processing entity sever computer 220 can aggregate all of the reward earnings that are due to a consumer and periodically send a consolidated statement credit file to the appropriate issuer 216 with instructions for posting the rewards/share to the consumer's statement to clear and settle these rewards.

It should be appreciated that the specific steps illustrated in FIG. 5 provide a particular method of processing rewards according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

Embodiments of the present invention can also be applied to off-line purchases made by a consumer. For example, consider that the payment processing network has direct agreements with a merchant for reward offers and a registered consumer makes an off-line purchase at the participating merchant. In this instance, the payment processing network receives consumer information as part of the payment authorization process for that transaction. The payment processing network can verify if the transaction qualifies for one or more rewards offered by the merchant and if it does, the payment processing network can create the settlement credit file and send it to the issuer after completion of the transaction. The issuer can then post the reward on the consumer's account statement.

In some embodiments, the rewards can take any number of forms such as, cash back, airline miles, points that can be redeemed for goods, etc. Many benefits can be realized by the rewards program described above. For instance, consumers would be inclined to make increasing purchases using particular payment devices (debit, credit or other) if issuers of these payment devices offer such rewards. In some embodiments, the payment processing network may garner an added percentage of revenue from the transaction (that portion which it retains) and may be able to remit a portion of those proceeds to the issuer in the form of revenue sharing to encourage the issuers to offer the reward program to their consumers/cardholders. Additionally, the rewards program may generate increased data and analytics to help the payment processing network and the issuers learn more about their consumers' online and offline shopping preferences that can be used for other value added services or for targeted marketing offers.

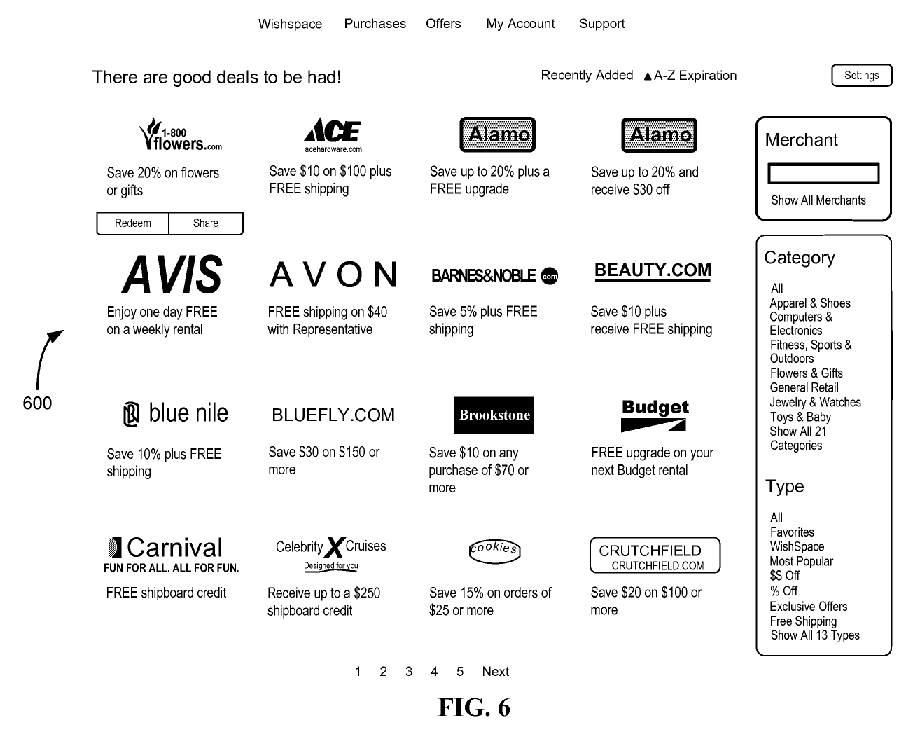

As discussed above, the payment processing network server computer 220 can host the merchant portal. FIG. 6 shows a sample screen 600 that the consumer may be presented with on the client computer 202 once the consumer logs on to the merchant portal 204, according to an embodiment of the present invention. As seen in sample screen 600, various merchant offers are displayed to the consumer and once the consumer clicks on any of the merchant offers, he may be directed to the merchant site (e.g., merchant site 210(a)) where the consumer can purchase items. It is to be noted that screen 600 is shown for illustrative purposes only and is not intended to limit the scope of any of the embodiments described herein in any manner. One skilled in the art will realize that there are many more ways presenting the merchant portal to the consumer. One skilled in the art will realize that there are many more ways of presenting the merchant portal and/or merchant offers to the consumer. For instance, merchant offers may be communicated to a consumer via the consumer's mobile communication device, or a targeted medium such as, a kiosk, an ATM, digital signage, television, or the like. The methods and systems for affiliate cash-back program described above are equally applicable regardless of the method of presenting a merchant offer to the consumer.

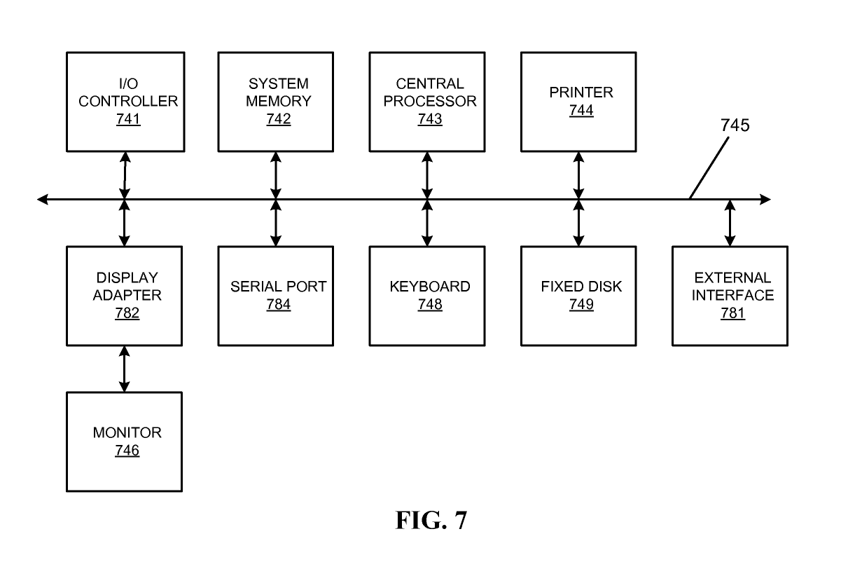

FIG. 7 is a high level block diagram of a computer system that may be used to implement any of the individual components described above and may include one or more of the subsystems or components shown in FIG. 7, which is a block diagram of a computer apparatus. The subsystems shown in FIG. 7 are interconnected via a system bus 745. Additional subsystems such as printer 744, keyboard 748, fixed disk 749, monitor 746, which is coupled to display adapter 782, and others are shown. Peripherals and input/output (I/O) devices, which couple to I/O controller 741, can be connected to the computer system by any number of means known in the art, such as serial port 784. For example, serial port 784 or external interface 781 can be used to connect the computer apparatus to a wide area network such as the Internet, a mouse input device, or a scanner. The interconnection via system bus 745 allows central processor 743 to communicate with each subsystem and to control the execution of instructions from system memory 742 or fixed disk 749, as well as the exchange of information between subsystems. The system memory 742 and/or fixed disk 749 may embody a computer readable medium.

Several benefits are realized by such an affiliate reward service. For the payment processing network that manages the merchant portal, this service/program can result in added revenue generation and help in fostering usage of credit and debit cards. In addition, the payment processing network can provide a value-added service to its clients. The data gathered as a result of the rewards service can be used by the payment processing network to target offers to consumer in a more effective manner.

For a payment device issuer, e.g., a bank, such a reward service can offer an additional revenue stream. In addition, the rewards service can encourage usage of payment devices online and may help in retention of consumers/card holders by the issuer. Similar to the payment processing network, the issuer can also use the gathered data for targeting offers and services to consumers more effectively. For the consumer, the rewards program offers an extra benefit on top of coupons and other offers. A consumer is much likely to be delighted to see credits on his/her statements for items that he/she would have bought regardless of the incentives.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method for managing a reward program, the method comprising, by a computer system:
providing a listing including one or more merchants to a consumer;
receiving authentication information, from a client computer operated by the consumer, and generating unique tracking information associated with the consumer;
receiving information, from the client computer, about selection of a merchant of the one or more merchants;
directing the client computer to a website of the selected merchant;
receiving purchase details about an item purchased by the consumer from the selected merchant, the purchase details including the unique tracking information; and
determining a first share from a total reward to be offered to the consumer based at least in part on the purchase details and the total reward.

2. The method of claim 1 wherein providing a listing including one or more merchants includes:
receiving the listing from an affiliate aggregator; and
providing the listing to the consumer, and
wherein the method further comprises receiving the total reward offered by the merchant for the item purchased by the consumer and communicating information about the first share to an issuer of the payment device, wherein the first share is included in an account statement provided to the consumer.

3. The method of claim 2 wherein providing the listing to a consumer includes:
displaying the listing of the one or more merchants including incentives offered by the one or more merchants at a dedicated a website or sending an email to the consumer including the listing of the one or more merchants.

4. The method of claim 1 wherein receiving purchase details about the item purchased by the consumer includes receiving the purchase details from an affiliate aggregator.

5. The method of claim 1 wherein determining the first share includes:
analyzing the purchase details;
matching the unique tracking information with the payment device; and
determining, based on one more criteria, the amount of reward to be offered to the consumer.

6. The method of claim 1 further comprising:
determining a second share from the total reward to be communicated to the affiliate aggregator;
determining a third share from the total reward to be communicated to the issuer; and
determining a fourth second share from the total reward to be retained;
wherein the second share, the third share, and the fourth share is determined based on predetermined criteria.

7. The method of claim 1 wherein the unique tracking information comprises one of a random number assigned to the consumer, an alias associated with the consumer, a cookie resident on the client computer, or a hash of a consumer account number.

8. A computer readable storage medium including instructions which when executed by a processor embedded in a computer system cause the processor to perform a method for managing rewards, the method comprising:
receiving authentication information of a consumer from a client computer operated by the consumer and generating unique tracking information associated with the consumer;
receiving information, from the client computer, about selection of a merchant of the one or more merchants;
directing the consumer to a website of the selected merchant;
receiving purchase details about an item purchased by the consumer from the selected merchant, the purchase details including the unique tracking information; and
determining a first share from a total reward to be offered to the consumer, based at least in part on the purchase details and the total reward.

9. The computer readable storage medium of claim 8 wherein the method further comprises:
calculating a second share, from the total reward, of the affiliate network;
calculating a third share, from the total reward, of the issuer of the payment device; and
retaining a fourth share from the total value of the incentive.

10. The computer readable storage medium of claim 8 wherein the total reward is in form of cash back, rewards points, or loyalty program points, and wherein the method further comprises receiving the total reward offered by the merchant for the item purchased by the consumer, and communicating information about the first share to an issuer of the payment device, wherein the first share is included in an account statement provided to the consumer.

11. The computer readable storage medium of claim 10 wherein communicating information about the first share first share to an issuer further includes providing the unique customer tracking information to the issuer.

12. The computer readable storage medium of claim 8 wherein calculating the first share of the consumer is performed based on one or more predetermined criteria.

13. A method comprising:
receiving, by a server computer, information about a consumer and information about a payment device associated with the consumer;
registering, by the server computer, the consumer as an authorized consumer;
providing, by the server computer, to a client computer, a listing of one or merchants;
receiving, by the server computer, input from the client computer indicating selection of a merchant from the one or merchants;
directing, by the server computer, the client computer to a website of the selected merchant;
receiving, by the server computer, details of transaction performed by the consumer with the selected merchant using the payment device;
receiving, by the server computer, a total reward awarded by the merchant for the transaction performed by the consumer;
determining, by the server computer, a first share of the consumer, a second share of an issuer of the payment device, and a third share to be retained by an entity managing the server computer; and
communicating, by the server computer, the first share to the issuer for inclusion in a statement provided to the consumer.

14. The method of claim 13 wherein providing a listing of one or merchants includes:
receiving the listing from an affiliate aggregator; and
providing the listing to the consumer via a website.

15. The method of claim 14 further comprising:
determining, by the server computer, a fourth share, from the total reward, to be allocated to the affiliate aggregator.

16. The method of claim 13 wherein receiving details of the transaction performed by the consumer includes receiving the details from an affiliate aggregator, wherein the details of the transaction include payment information and unique tracking information associated with the consumer.

17. The method of claim 16 wherein determining a first share of the consumer comprises:
matching the unique tracking information associated with the consumer to the payment device used by the consumer to perform the transaction; and
determining the first share based on the details of the transaction and a criteria established by the issuer of the payment device.

18. The method of claim 13 wherein providing a listing of one or merchants comprises:
providing the listing of the one or merchants on a web portal operated by a payment processing network; or
providing the listing of the one or merchants on an issuer-branded web portal.

19. A system for managing a reward program, the system comprising:
a server computer configured to host a merchant portal displaying a listing of one or more merchants offering an incentive to consumers;
an affiliate aggregator communicably coupled to the server computer and configured to provide information about the one more merchants to the server computer; and
an issuer computer communicably coupled to the server computer and configured to receive information about a reward share for a consumer and include the reward share on a statement provided to the consumer, the issuer being associated with a payment device used by the consumer;
wherein the server computer is further configured to:
receive information, from the affiliate aggregator, about a transaction performed by the consumer, using the payment device, at a merchant location and a total reward offered by the merchant for the transaction;
calculate a first share of the consumer, a second share for the affiliate aggregator, a third share for the issuer, and a fourth share to be retained by a payment processing network managing the server computer.

20. The system of claim 19 wherein the server computer is further configured to include the first share of the consumer directly on the statement provided to the consumer.

21. The system of claim 19 wherein the server computer is further configured to receive, from the affiliate aggregator, information about unique tracking information associated with the consumer.
